(19) United States
(12) Patent Application Publication
(10) Pub. No.: US 2020/0364104 A1
(43) Pub. Date: Nov. 19, 2020

(54) IDENTIFYING A PROBLEM BASED ON LOG DATA ANALYSIS

(71) Applicant: International Business Machines Corporation, Armonk, NY (US)

(72) Inventors: Yuk L. Chan, Rochester, NY (US); Lei Yu, Marietta, GA (US); Qi Zhang, Elmsford, NY (US); Hong Min, Poughkeepsie, NY (US); Santiago Ortega, Raleigh, NC (US); Matt Hogstrom, Cary, NC (US); Bradford Austin Fisher, Chapel Hill, NC (US)

(21) Appl. No.: 16/415,131

(22) Filed: May 17, 2019

(51) Int. Cl. G06F 11/07; G06F 16/901; G06N 20/00; G06F 17/50

(52) U.S. Cl. CPC G06F 11/079; G06F 11/0709; G06F 11/0751; G06F 17/5009; G06F 16/9024; G06N 20/00; G06F 11/0778

(57) ABSTRACT

In one example implementation according to aspects of the present disclosure, a computer-implemented method includes training, by a processing device, a log sequence model based at least in part on training log messages. The method further includes integrating, by the processing device, a system-level model and a component-level model to detect a relationship or an anomaly. The method further includes identify, by the processing device, a workflow as a directed graph. The method further includes matching, by the processing device, the workflow to a system configuration graph. The method further includes identifying, by the processing device, a problem based at least in part on one or more of the system configuration graph and results of the matching of the workflow and the system configuration graph.

### BACKGROUND

The present invention generally relates to computing systems, and more specifically, to identifying a problem based on log data analysis.

Computing systems log events as log data. Events can be generated by firmware, operating systems, middleware, and applications. As an example, an application generates events, and thus log data associated with the events, during normal operations and/or during abnormal conditions. The log data can be viewed and analyzed to identify, diagnosis, and prevent problems. As computing systems have become more complex, the number of events (and consequently, the amount of log data) has increased significantly.

### SUMMARY

Embodiments of the present invention are directed to a computer-implemented method for identifying a problem based on log data analysis. A non-limiting example of the computer-implemented method includes training, by a processing device, a log sequence model based at least in part on training log messages. The method further includes integrating, by the processing device, a system-level model and a component-level model to detect a relationship or an anomaly. The method further includes identify, by the processing device, a workflow as a directed graph. The method further includes matching, by the processing device, the workflow to a system configuration graph. The method further includes identifying, by the processing device, a problem based at least in part on one or more of the system configuration graph and results of the matching of the workflow and the system configuration graph.

Embodiments of the present invention are directed to a system. A non-limiting example of the system includes a memory comprising computer readable instructions and a processing device for executing the computer readable instructions for performing a method for identifying a problem based on log data analysis. A non-limiting example of the method includes training, by a processing device, a log sequence model based at least in part on training log messages. The method further includes integrating, by the processing device, a system-level model and a component-level model to detect a relationship or an anomaly. The method further includes identify, by the processing device, a workflow as a directed graph. The method further includes matching, by the processing device, the workflow to a system configuration graph. The method further includes identifying, by the processing device, a problem based at least in part on one or more of the system configuration graph and results of the matching of the workflow and the system configuration graph.

Embodiments of the invention are directed to a computer program product. A non-limiting example of the computer program product includes a computer readable storage medium having program instructions embodied therewith. The program instructions are executable by a processor to cause the processor to perform a method for identifying a problem based on log data analysis. A non-limiting example of the method includes training, by a processing device, a log sequence model based at least in part on training log messages. The method further includes integrating, by the processing device, a system-level model and a component-level model to detect a relationship or an anomaly. The method further includes identify, by the processing device, a workflow as a directed graph. The method further includes matching, by the processing device, the workflow to a system configuration graph. The method further includes identifying, by the processing device, a problem based at least in part on one or more of the system configuration graph and results of the matching of the workflow and the system configuration graph.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments described herein;

FIG. 2 depicts abstraction model layers according to one or more embodiments described herein;

FIG. 3 depicts a block diagram of a processing system for implementing the presently described techniques according to one or more embodiments described herein;

FIG. 4 depicts a flow diagram of a method for problem diagnosis and failure prevention based on log data analysis according to one or more embodiments described herein;

FIG. 5 depicts an example where a relationship is detected at the component level but not the system level according to one or more embodiments described herein;

FIG. 6 depicts workflows in the system involve a sequence of task executions or concurrent executions according to one or more embodiments described herein;

FIG. 7 depicts a system configuration graph (e.g., a Discovery Library Adapter (DLA)) that provides a static view of the correlations at the software component level according to one or more embodiments described herein;

FIG. 8A depicts an example of a workflow and a system configuration graph according to one or more embodiments described herein;

FIG. 8B depicts the workflow of FIG. 8A where each node in the workflow represents a program action owned by a software component in the system configuration graph according to one or more embodiments described herein;

FIG. 8C depicts examples of multiple distinct labeled graphs according to one or more embodiments described herein;

FIG. 8D depicts a mapping between the multiple distinct labeled graphs of FIG. 8C and matching subgraphs of the system configuration graph according to one or more embodiments described herein; and

FIG. 9 depicts a flow diagram of a method for identifying a problem based on log data analysis according to examples of the present disclosure.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

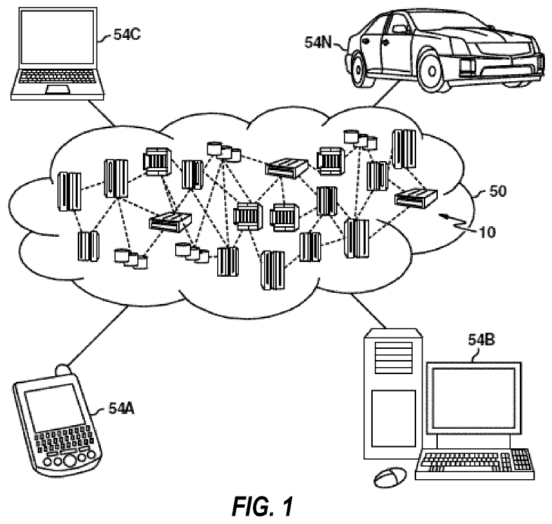

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

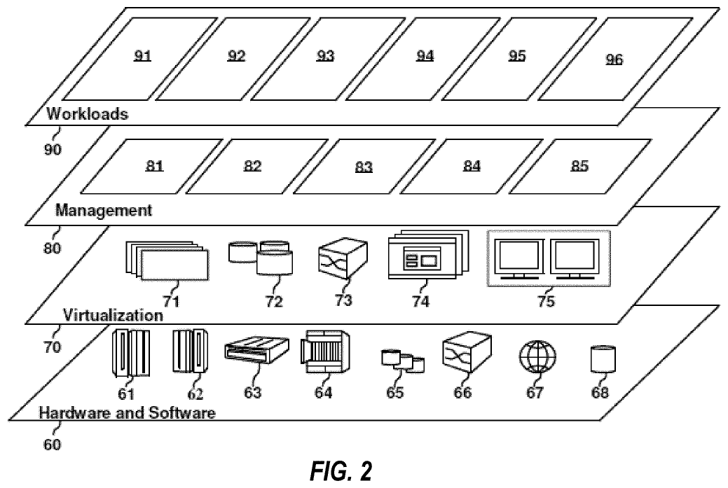

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and problem diagnosis and failure prevention 96.

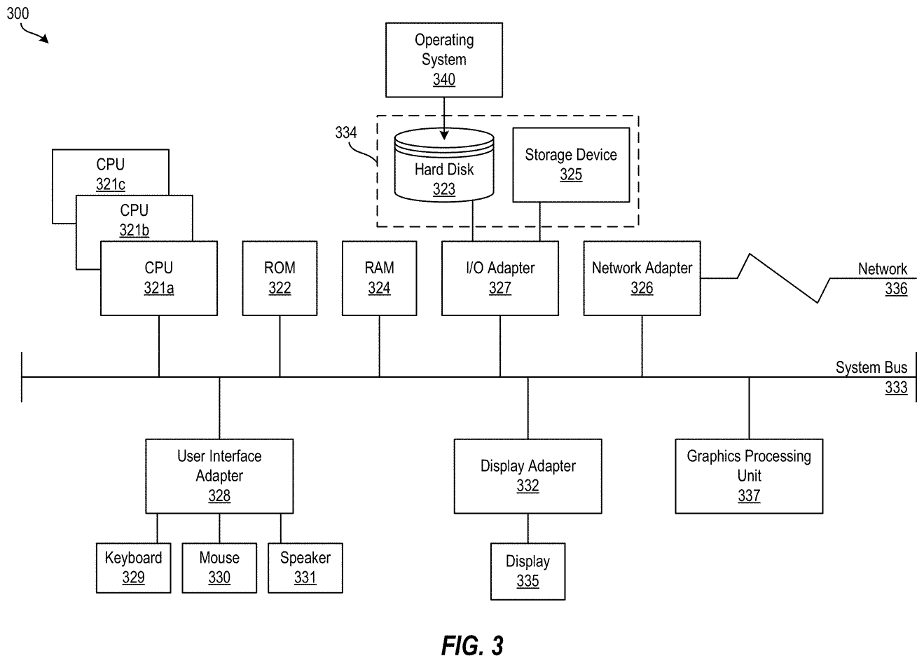

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a storage device 325 or any other similar component. I/O adapter 327, hard disk 323, and storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adapter 332, which may include a graphics adapter to improve the performance of graphics intensive applications and a video controller. In one aspect of the present disclosure, adapters 326, 327, and/or 332 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store the operating system 340 such as the AIX® operating system from IBM Corporation to coordinate the functions of the various components shown in processing system 300.

Turning now to an overview of technologies that are more specifically relevant to aspects of the invention, the present disclosure provides for identifying a problem based on log data analysis. In complex computing systems, problem diagnosis and failure prevention are challenging due to the increasing number of inter-lived logs generated from running components on a system, which can range from firmware, operating systems, middleware, and software applications. For example, log data can be produced by each software application during normal and abnormal operating conditions. Without an understanding of the execution correlations among the software applications, the log data only provide limited and localized views of the entire computing system from a resiliency perspective.

For example, a failure in a component in an upper software stack of a software application is triggered by an alarming event that has occurred earlier in a lower software stack. When the lower stack is common to multiple upper-level applications, it is difficult to predict which application(s) might fail later in order to take preventive actions in advance. Regarding problem determination, when a failure has already occurred, tracking back to what might have been the cause from other components in the system is useful to resolve the issue from the actual source of the failure.

Turning now to an overview of the aspects of the invention, one or more embodiments of the invention address the above-described shortcomings of the prior art by applying machine learning techniques to build a log sequence model and identify an activity workflow of the computing system. This is coupled with configuration dependency information within the computing system and among the components thereof over aggregated log data collected in the system to perform problem diagnosis and failure prevention.

The present techniques utilize the following: modeling a log sequence, integrating a system level model and a component model, identifying a workflow, and matching a workflow graph with a system configuration graph for problem diagnosis and consequent prevention.

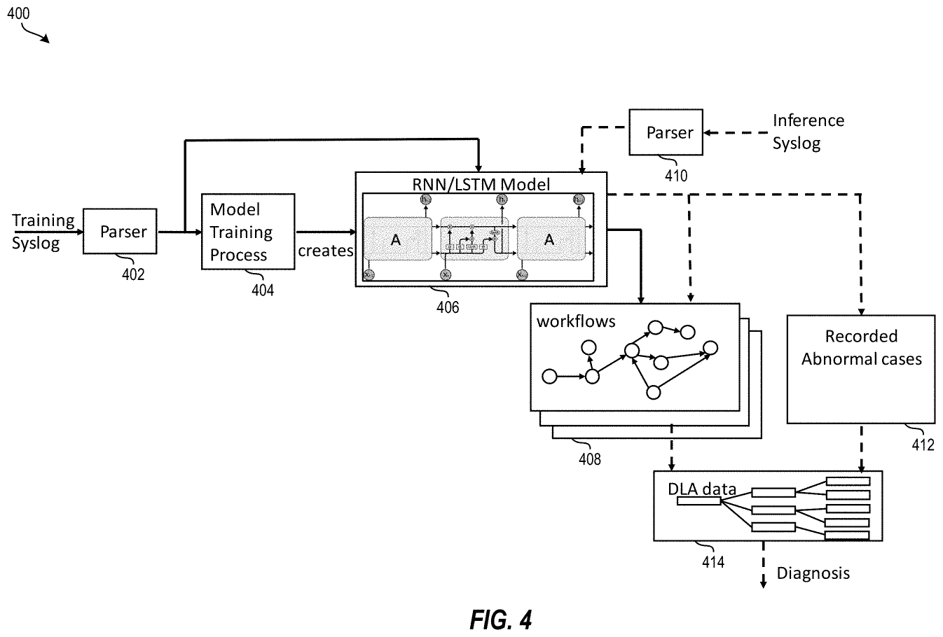

Turning now to a more detailed description of aspects of the present invention, FIG. 4 depicts a flow diagram of a method 400 for problem diagnosis and failure prevention based on log data analysis according to one or more embodiments described herein. In the example of FIG. 4, the solid arrows represent a training flow and the dashed arrows represent an inference path (i.e., the application of a trained model).

In this example training proceeds as follows. A parser 402 receives training log data as a “training syslog.” The training syslog represents, for example, IBM zOS logs of each component of a processing system as a merged log. The parser 402 parses the training syslog into event records, which are then fed into a model training process module 404 and a recurrent neural network/long short term memory (RNN/LSTM) model module 406. The model training process module 404 applies machine learning techniques to train on log messages and produce a log sequence model for prediction and abnormality detection.

According to examples described herein, the model training process module 404 can utilize machine learning functionality to accomplish the various operations of the model training process module 404 described herein. More specifically, the model training process module 404 can incorporate and utilize rule-based decision making and AI reasoning to accomplish the various operations of the model training process module 404 described herein. The phrase “machine learning” broadly describes a function of electronic systems that learn from data. A machine learning system, engine, or module can include a trainable machine learning algorithm that can be trained, such as in an external cloud environment, to learn functional relationships between inputs and outputs that are currently unknown, and the resulting model can be used by the model training process module 404 to identify workflows and perform problem diagnosis and sequence prediction. In one or more embodiments, machine learning functionality can be implemented using an artificial neural network (ANN) having the capability to be trained to perform a currently unknown function. In machine learning and cognitive science, ANNs are a family of statistical learning models inspired by the biological neural networks of animals, and in particular the brain. ANNs can be used to estimate or approximate systems and functions that depend on a large number of inputs.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was read.

With continued reference to FIG. 4, in some examples, the log data (i.e., component log messages) of the training syslog are merged and ordered by time. Log messages are treated similarly as language training. In an example, an objective may be to understand the meaning of a sentence. If the language feature does not affect the meaning, the language feature can be excluded from the analysis. Similarly, each message can be treated as a “word” or “key,” excluding the variable part. For example, in the messages “database restarted with recovery log record position #1” and “database restarted with recovery log record position #2,” the key here is “database restarted with recovery log record position.” The variable parts “#1” and “#2” are ignored. This extraction is performed by the parser 402 after scanning through the training syslog. A sequence of keys that repeatedly appear in the log can be treated like phrases are treated in language processing. In another example, if the language feature is useful in determining the meaning, the “word” or “key” of the message will contain elements of these features such that two different features (#1 and #2) will result in two different “keys.”

Like text and language machine learning training, a model is trained in the training process 404 to predict a next likely word or phrase. When log messages (with only the keys remaining) are passed to the model training process 404, a trained model is created for predicting the next message key based on historical observations.

In a system with many components, a training set can be generated in the following ways. As a first example, the log messages can be partitioned by components, for example, to aggregate application server logs together and database logs together. In such cases, for a component with multiple instances, such as database servers, log message partitioning can be done at the instance level. This enables the elimination of the interference among instances and more accurate message extraction. As a second example, the log messages can be partitioned by a time interval. Partitioning by components tends to produce a training model that like predicts the next message within each component, with less noise from other components. Partitioning by time interval tends to produce a training model that captures inter-components operation information. In another example, a job running on IBM's z/OS is associated with a “Jobname” When a job is submitted, a unique identifier called “Jobid” is assigned to the running instance of the job. These jobs write log messages to a common log destination called “syslog.” The training data can be extracted from the syslog based on the Jobid and Jobname.

In examples, nested training can be used to produce models with different granularities. For example, a coarse-grained model captures sequence information among components while a finer-grained model captures information within components. At the inference/prediction phase, the coarse-grained model is first applied and then the finer-grained model(s) are applied.

In other examples, two models can be trained separately, using component-based partitioning and/or time interval-based partitioning. At prediction time, the inference results for consequence prediction can be merged.

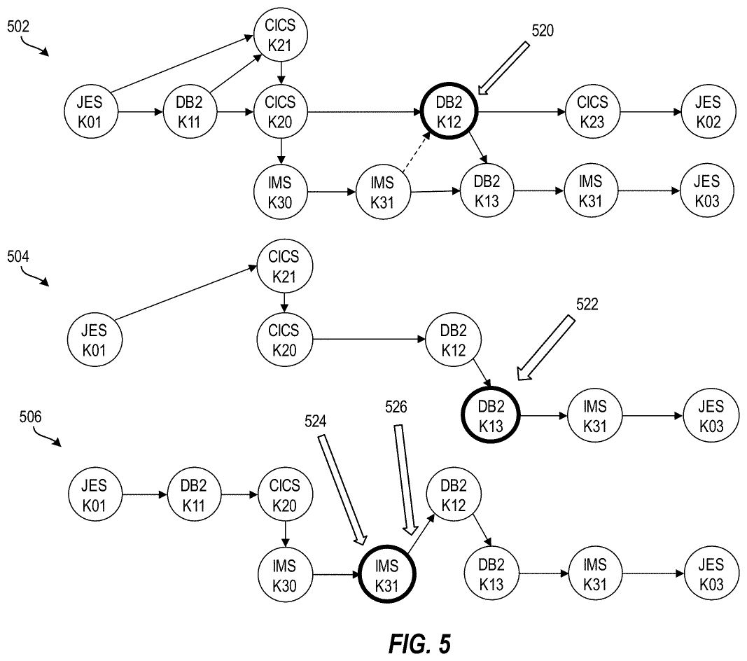

The RNN/LSTM model module 406 integrates a system-level model and a component. The system-level model and component model can infer results from each other. FIG. 5 depicts an example where a relationship is detected at the component level but not the system level. FIG. 5 includes a system level model 502, an Event 1 model 504, and an Event 2 model 506 (i.e., component level models). The Event 1 and Event 2 models 504, 506 can represent a credit card service or an accounting job instance, for example. In the example of FIG. 5, the Event 2 model 204 shows a relationship 526 that exists but is not detected in the system level model 502. Anomalies 520, 522, 524 are detected independently at the system level, Event 1 level, and Event 2 level respectively. When these anomalies 520, 522, 524 are analyzed together, a relationship between the three anomaly nodes can be identified (e.g., the relationship 526). As an example, by combining the system level model 502 and component models (e.g., the event models 504, 506), the component and system level anomaly and their associated inference to each other can be inferred.

With continued reference to FIG. 4, once the log sequence modeling is performed and the system level model and event/component level models are integrated, workflow identification occurs. A workflow describes a sequence of system/software events within a component or across multiple components. A workflow can be represented as a directed graph, which log keys as graph nodes, and the directed edges indicate the sequential relationships between log keys (i.e., graph nodes).

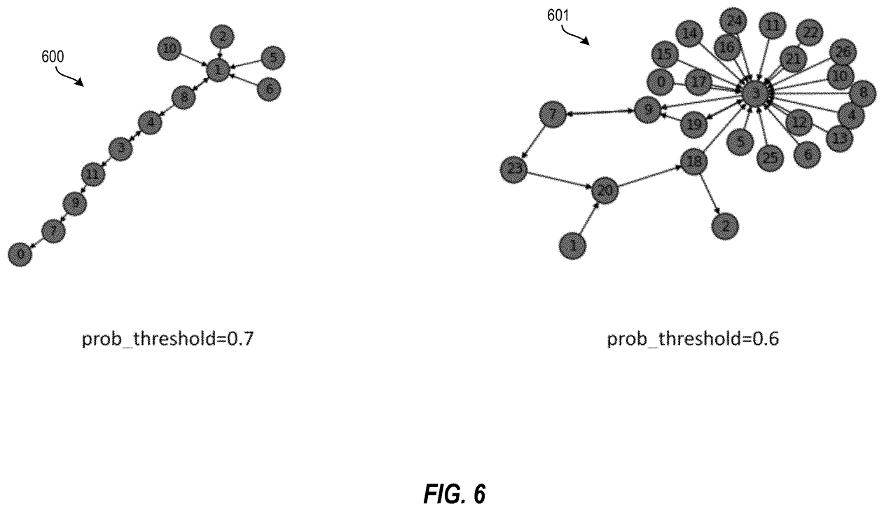

As depicted in FIG. 6, workflows 600, 601 in the system involve a sequence of task executions or concurrent executions. Because each log message represents a program event, the workflows 600, 601 can be discovered by mining the invariant log sequence pattern from its respective log data. Log messages from different workflows are often mixed together. To address this problem, several approaches can be implemented for workflow identification.

As one example, with reference to FIG. 4, the workflow module 408 uses the learned log sequence model from the RNN/LSTM model module 406. Using a random “key,” the workflow module 408 begins a traversal based on the prediction of the next keys in the sequence and their likelihood values produced by the model to determine if the next keys meet the traversal threshold. The workflow module 408 records the traversed path as workflows (e.g., one of the workflows 600, 601). In the example of FIG. 6, the workflow 600 is based on a threshold of 0.7 while the workflow 601 is based on a threshold of 0.6. In other examples, the workflow module 408 can apply a hidden Markov model or perform automaton using a state machine to perform workflow identification.

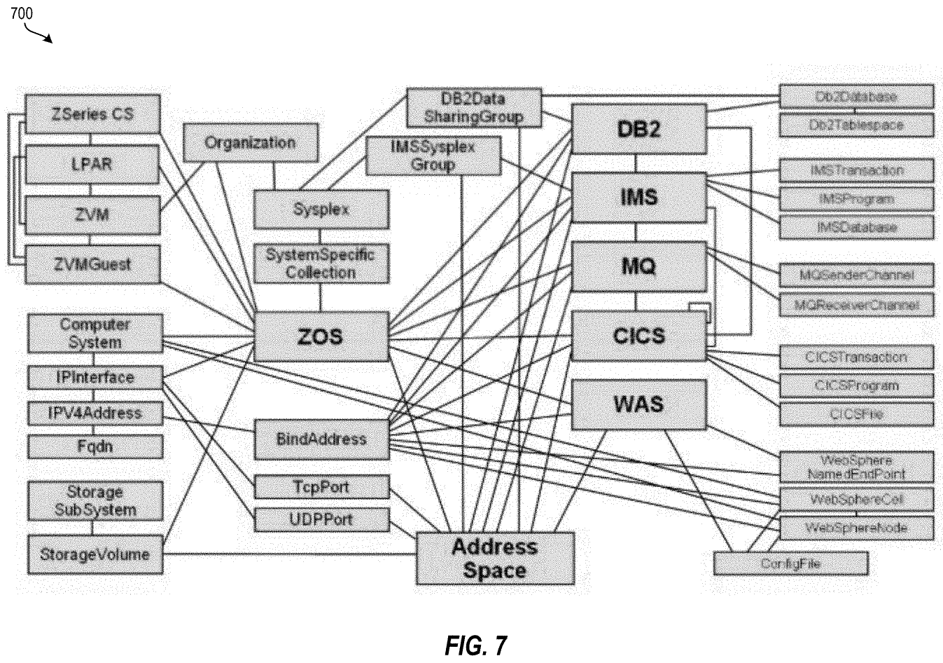

With continued reference to FIG. 4, once workflows are identified, the workflow graph is mapped with the system configuration graph for problem diagnosis and consequence prediction. A workflow graph describes the dynamic component correlations at the task execution level. With reference to FIG. 7, a system configuration graph 700 (e.g., a Discovery Library Adapter (DLA)) provides a static view of the correlations at the software component level as shown in the example of FIG. 7. The system configuration graph 700 complements workflows on missed correlations while the workflow complements the system configuration graph 700 on system dynamics such as temporal patterns.

With continued reference to the example shown in FIG. 4, problem diagnosis and consequence prediction is performed on inference syslog data. Accordingly, the model is applied (i.e., in the inference path shown by the dashed arrows) to an inference syslog. The inference syslog is parsed by a parser 410 similarly to the parsing by the parser 402.

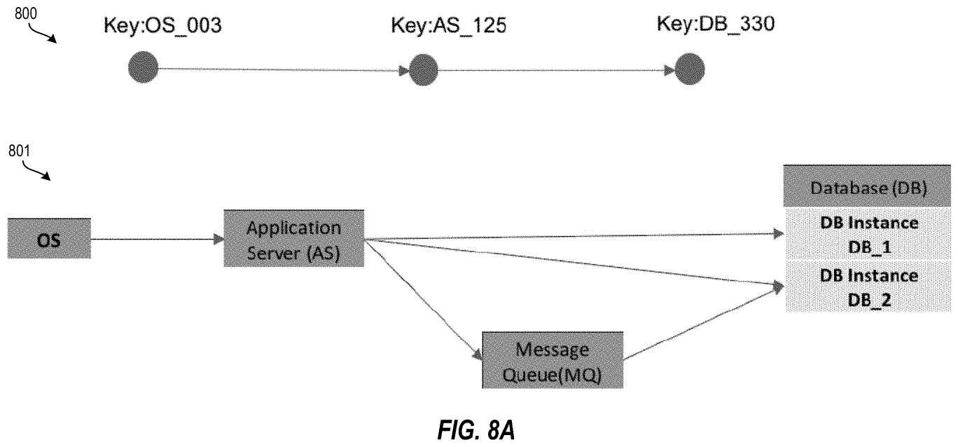

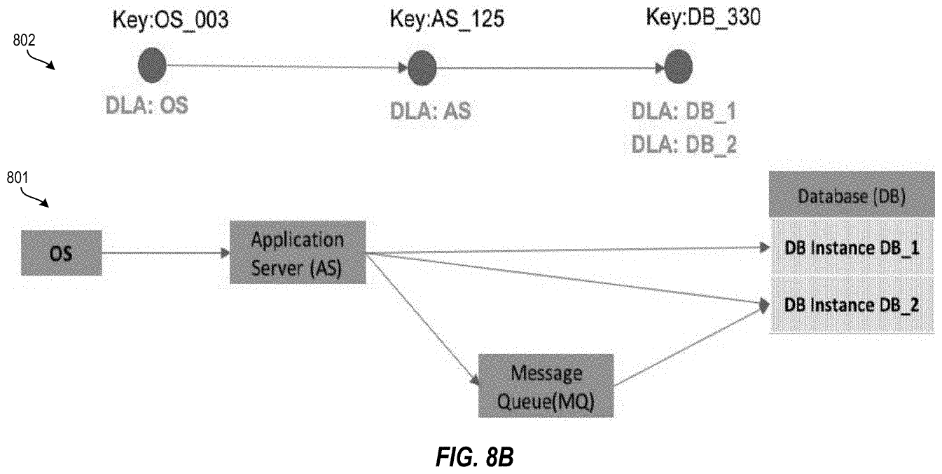

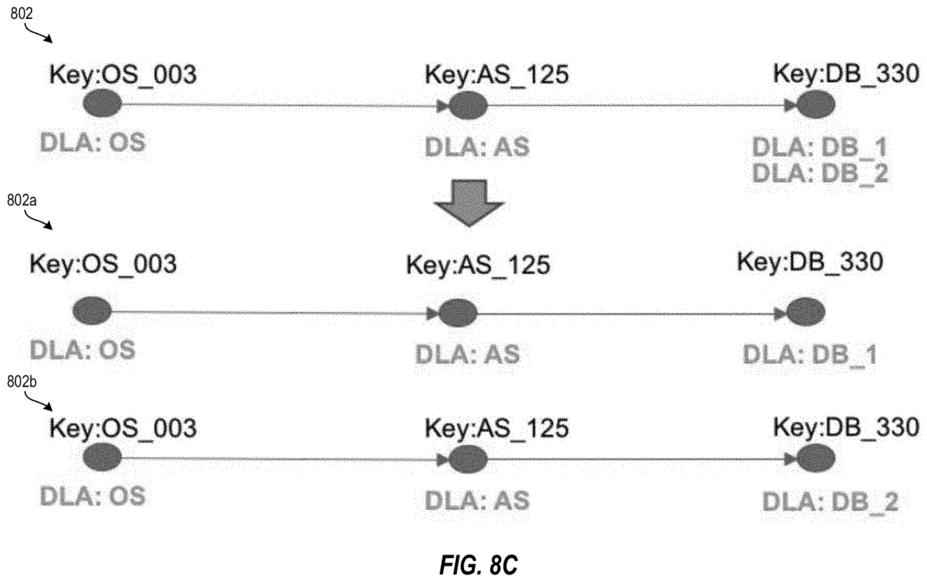

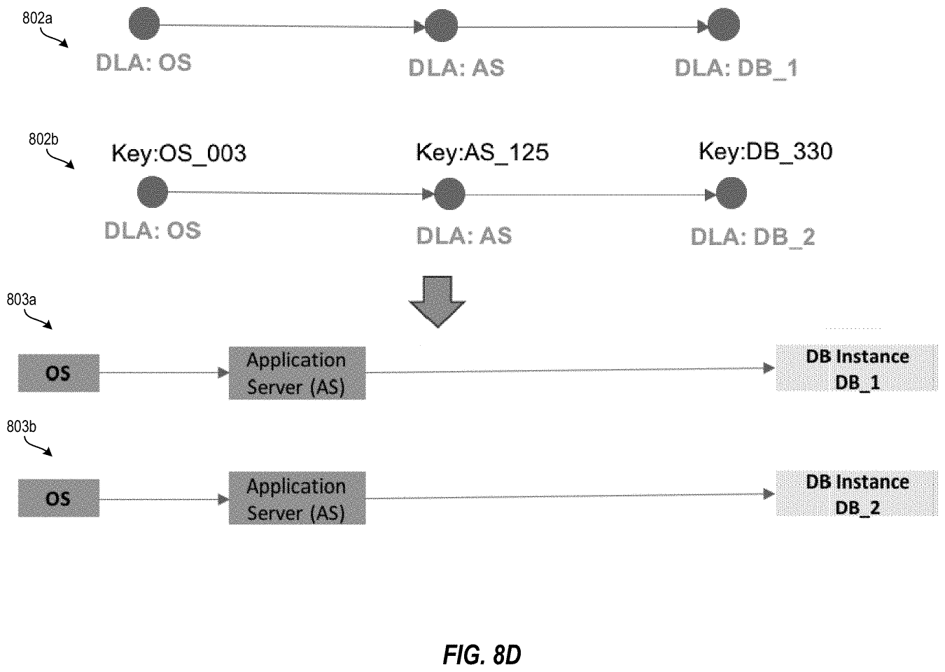

Problem diagnosis and consequence prediction on the inference syslog data is performed at problem diagnosis and consequence prediction module 414 as follows with reference to FIGS. 8A, 8B, 8C, and 8D. The problem diagnosis and consequence prediction module 414 utilizes the workflows from the workflow module 408 and previously recorded abnormal cases 412. FIG. 8A depicts an example of a workflow 800 and a system configuration graph 801. In this example, the workflow 800 is constructed via observation from log messages (e.g., for problem root cause analysis) and/or partially collected from log messages and partially from the inference based on the trained model and the observed log messages.

As shown in FIG. 8B, each node in the workflow 800 of FIG. 8A represents a program action owned by a software component in the system configuration graph 801 (e.g., referred to as “DLA” in FIGS. 8A-8D). For example, Key:OS_003 is owned by DLA:OS; Key:AS_125 is owned by DLA:AS; and KEY:DB_330 is owned by DLA:DB_1 and DLA:DB_2. This is reflected as a labeled connected graph 802. The key for a workflow node includes information indicating its owning software component from the system configuration graph 801. The software component is added to the workflow node labels in examples. Additionally, it is possible that, as shown, multiple instances of a single software are running on the system. In such cases, each instance is added to the node labels (see, e.g., the node labeled Key:DB_330).

As shown in FIG. 8C, the labeled connected graph 802 of FIG. 8B can be decomposed from the illustration of FIG. 8B such that multiple distinct labeled graphs 802a, 802b are created. In such cases, each node in each of the multiple distinct labeled graphs 802a, 802b only has one DLA label as shown. The various possible combinations from the labeled connected graph 802 of FIG. 8B are exhausted as shown in FIG. 8C represented by the multiple distinct workflows 802a, 802b.

As shown in FIG. 8D, for each of the multiple distinct workflows 802a, 802b, its connecting matching subgraph 803a, 803b of the system configuration graph 801 can be determined. Each identified DLA subgraph 803a, 803b represents the software stack relevant to the workflow's program or potential consequence.

Once a diagnosis is generated by the problem diagnosis and consequence prediction module 414, the diagnosis can be used to prevent future failures by addressing the cause of the problem. For example, if an anomaly is detected or a previously unknown relationship is identified, steps can be taken to correct the failure. Because the present techniques identify and diagnose problems that may not otherwise be identifiable, the present techniques improve the functioning of computing systems.

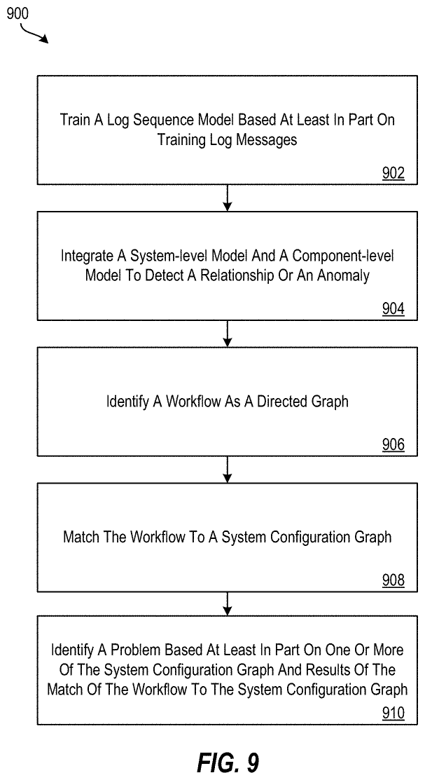

FIG. 9 depicts a flow diagram of a method 900 for problem diagnosis and failure prevention based on log data analysis according to examples of the present disclosure. The method 900 can be performed, for example, by the modules/components of FIG. 4 and/or by another suitable processing system (e.g., the processing system 300, the cloud computing environment 50) or processing device (e.g., the processor 321).

At block 902, the model training process module 402 trains a log sequence model based at least in part on log messages. At block 904, the RNN/LSTM model module 406 integrates a system-level model and a component-level model to detect a relationship or an anomaly. AT block 906, the workflows module identifies a workflow as a directed graph (e.g., the workflows 600, 601 of FIG. 6). At block 908, the problem diagnosis and consequence prediction module 414 matches the workflow to a system configuration graph. At block 910, the problem diagnosis and consequence prediction module 414 identifies a problem based at least in part on one or more of the system configuration graph and results of matching the workflow to the system configuration graph to generate a diagnosis.

Additional processes also may be included, and it should be understood that the process depicted in FIG. 9 represents an illustration, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
training, by a processing device, a log sequence model based at least in part on training log messages;
integrating, by the processing device, a system-level model and a component-level model to detect a relationship or an anomaly;
identify, by the processing device, a workflow as a directed graph;
matching, by the processing device, the workflow to a system configuration graph; and
identifying, by the processing device, a problem based at least in part on one or more of the system configuration graph and results of the matching of the workflow to the system configuration graph.

2. The computer-implemented method of claim 1, further comprising:
prior to training the model, parsing the log messages, wherein the model is trained based at least in part on the parsed log messages.

3. The computer-implemented method of claim 1, further comprising:
correcting the cause of the anomaly based at least in part on the identified problem.

4. The computer-implemented method of claim 1, wherein the training log messages are generated based at least in part on partitioning log messages by components.

5. The computer-implemented method of claim 1, wherein the training log messages are generated based at least in part on partitioning log messages by time interval.

6. The computer-implemented method of claim 1, wherein the system configuration graph is a discovery library adapter graph.

7. The computer-implemented method of claim 1, wherein matching the workflow to the system configuration graph comprises decomposing the workflow into a plurality of distinct labeled graphs.

8. A system comprising:
a memory comprising computer readable instructions; and
a processing device for executing the computer readable instructions for performing a method comprising:
training, by the processing device, a log sequence model based at least in part on training log messages;
integrating, by the processing device, a system-level model and a component-level model to detect a relationship or an anomaly;
identify, by the processing device, a workflow as a directed graph;
matching, by the processing device, the workflow to a system configuration graph; and
identifying, by the processing device, a problem based at least in part on one or more of the system configuration graph and results of the matching of the workflow to the system configuration graph.

9. The system of claim 8, wherein the method further comprises:
prior to training the model, parsing the log messages, wherein the model is trained based at least in part on the parsed log messages.

10. The system of claim 8, wherein the method further comprises:
correcting the cause of the anomaly based at least in part on the identified problem.

11. The system of claim 8, wherein the training log messages are generated based at least in part on partitioning log messages by components.

12. The system of claim 8, wherein the training log messages are generated based at least in part on partitioning log messages by time interval.

13. The system of claim 8, wherein the system configuration graph is a discovery library adapter graph.

14. The system of claim 8, wherein matching the workflow to the system configuration graph comprises decomposing the workflow into a plurality of distinct labeled graphs.

15. A computer program product comprising:
a computer readable storage medium having program instructions embodied therewith, the program instructions executable by a processing device to cause the processing device to perform a method comprising:
training, by the processing device, a log sequence model based at least in part on training log messages;
integrating, by the processing device, a system-level model and a component-level model to detect a relationship or an anomaly;
identify, by the processing device, a workflow as a directed graph;
matching, by the processing device, the workflow to a system configuration graph; and
identifying, by the processing device, a problem based at least in part on one or more of the system configuration graph and results of the matching of the workflow to the system configuration graph.

16. The computer program product of claim 15, wherein the method further comprises:
prior to training the model, parsing the log messages, wherein the model is trained based at least in part on the parsed log messages.

17. The computer program product of claim 15, wherein the method further comprises:
correcting the cause of the anomaly based at least in part on the identified problem.

18. The computer program product of claim 15, wherein the training log messages are generated based at least in part on partitioning log messages by components.

19. The computer program product of claim 15, wherein the training log messages are generated based at least in part on partitioning log messages by time interval.

20. The computer program product of claim 15, wherein the system configuration graph is a discovery library adapter graph.
